(19) United States
(12) Patent Application Publication
(10) Pub. No.: US 2024/0141502 A1
(43) Pub. Date: May 2, 2024

(54) METAL SURFACE TREATMENT AGENT

(71) Applicant: Hitachi, Ltd., Tokyo (JP)

(72) Inventors: Nobuhito KATSUMURA, Tokyo (JP); Yasuhiro YAMAOKA, Tokyo (JP); Osamu UHARA, Tokyo (JP)

(21) Appl. No.: 18/242,032

(22) Filed: Sep. 5, 2023

(30) Foreign Application Priority Data
Nov. 2, 2022 (JP) 2022-176462

(51) Int. Cl. C23C 22/05

(52) U.S. Cl. CPC C23C 22/05; C23C 2222/20

(57) ABSTRACT

To provide metal surface treatment agents with excellent adhesion to metal surfaces. A metal surface treatment agent comprising first silane compound containing a functional group that chemically bonds to the metal surface and a functional group that chemically bonds to the coating film, second silane compound containing a functional group that chemically bonds to the metal surface and a functional group that provides rust inhibiting properties to the metal, and a solvent mixture of organic solvent and water.

### CROSS-REFERENCE TO RELATED APPLICATION

The present application claims priority from Japanese application JP2022-176462, filed on Nov. 2, 2022, the content of which is hereby incorporated by reference into this application.

### TECHNICAL FIELD

The present invention relates to a metal surface treatment agent.

### BACKGROUND ART

Many structures, including buildings and moving vehicles, are coated to add design and protection. In particular, for mobile vehicles such as railroad vehicles and automobiles, it is necessary to smooth the surface of the paint film in order to add aesthetics and reduce aerodynamic drag. It is common practice to treat the surface to be coated before applying such a coating. For example, for metals, physical treatments such as blasting and polishing, phosphating and zirconium treatments are used.

However, according to these technologies, the physical method causes problems such as coating film peeling due to powder used for blasting and polishing debris remaining on the coated surface, and the chemical conversion treatment requires the preparation of multiple tanks such as a washing tank, a treatment tank, and a rinsing tank. In particular, large sized products such as railroad vehicles require large tanks and generate a large amount of waste liquid. As a technology to solve these inconveniences, a surface treatment using a silane compound, for example, has been proposed (see, for example, patent document 1). This technology is expected to be effective in ensuring coating reliability by providing adequate adhesion to the coating film simply by spraying or brushing, without generating polishing debris or requiring investment in equipment such as tanks.

### CITATION LIST

### Patent Document

[Patents 1] Japanese unexamined patent publication No. 2017-43845

### SUMMARY OF THE INVENTION

### Problems to be Solved by the Invention

When surface treatment of metal surfaces is performed using the conventional techniques described above, it is important to uniformly treat the entire surface with appropriate surface treatment agents. Appropriate surface treatment agents are those that ensure strong chemical bonding between the metal and the coating film to be applied to the surface and protect the metal surface from corrosion. The surface treatment agents must be uniformly applied to the metal surface, and the wetting of the surface treatment agents on the metal surface must be good. If the wetting is not good, the surface treatment agents will adhere unevenly to the surface, resulting in areas that are not wetted or areas where large amounts of surface treatment agents are inappropriately applied, causing the paint to peel off.

The purpose of the present invention is to provide a metal surface treatment agent with excellent adhesion to metal surfaces.

The present invention is a metal surface treatment agent comprising a first silane compound containing a functional group first silane compound containing a functional group that chemically bonds to the metal surface and a functional group that chemically bonds to the coating film, second silane compound containing a functional group that chemically bonds to the metal surface and a functional group that provides rust inhibiting properties to the metal, and a solvent mixture of organic solvent and water.

### Effects of the Invention

The present invention enables metal surface treatment agents with excellent adhesion to metal surfaces.

### BRIEF DESCRIPTION OF DRAWINGS

FIG. 1 Schematic cross-sectional view of a coating film showing the first embodiment.

FIG. 2 This is a vehicle with a paint part.

FIG. 3 Table 1-1.

FIG. 4 Table 1-2.

FIG. 5 Table 2.

### MODE FOR CARRYING OUT THE INVENTION

The vehicle of the present disclosure is a vehicle having a painted part with a painted surface, the painted part comprising metal structures, a surface treatment layer applied on the metal structures, and a coating film provided on the surface. The surface treatment layer is positioned between the surface of the metal structures and the coating film and composed of a compound containing silane in its molecular framework.

The embodiments of the invention will be described below with reference to the drawings, but the invention is not limited only to the embodiments described in the drawings. The configuration of the vehicle other than the paint part is the same as that of the vehicle in the known art, so a detailed description will be omitted.

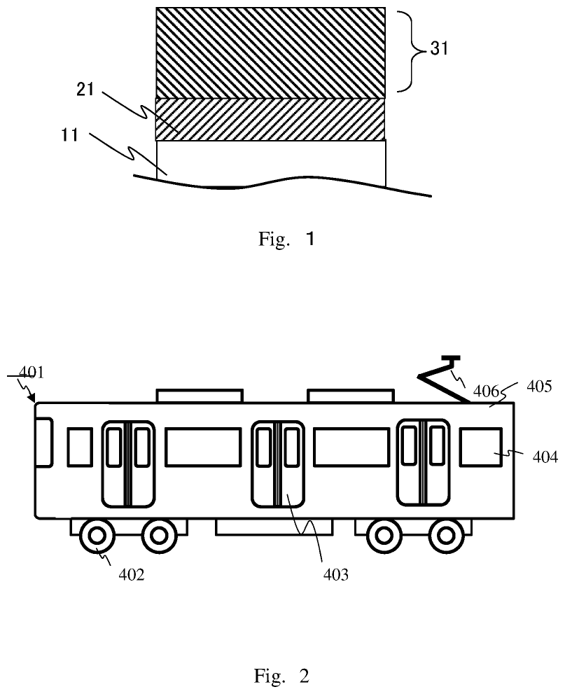

FIG. 1 is a schematic cross-sectional view of a coating film showing an embodiment. The vehicle 401 shown in FIG. 2 is a vehicle having a paint part 405 with a painted surface, wherein the paint part 405, as shown in FIG. 1, is schematically composed of metal structures 11, a surface treatment layer 21, and the paint part 405 is composed of metal structures 11, surface treatment layer 21, and coating film 31, as shown in FIG. 1.

The metal structures 11 are composed, for example, of sheet metal formed from metal materials in accordance with the shape of the object. For example, steel, aluminum alloys, stainless steel, duralumin, etc., or CFRP (carbon reinforced plastic), GFRP (glass fiber reinforced plastic), etc. can be partially used as the above metal materials.

The surface treatment layer is a layer provided on the metal structures by applying and drying surface treatment agents.

Surface treatment layer 21 is a layer for adhering metal structures 11 and coating film 31. For example, when manufacturing the vehicle 401, it is formed to cover the surface of the metal structure as a base for the coating film 31.

The surface treatment agents comprising a silane compound that contains silane in its molecular structure and includes a functional group that chemically bonds to the metal silane compounds comprising a functional group that chemically bonds to a metal surface and a functional group that chemically bonds coating film (a) and silane compounds comprising a functional group that chemically bonds metal surfaces and a functional group that provides corrosion inhibiting properties to metals (b), or silane compounds comprising a functional group that chemically bonds to a metal surface and a functional group that chemically bonds coating film (a) and silane compounds comprising a functional group that chemically bonds metal surfaces and a functional group that provides rust resistance to metals (b) are exemplified.

Methoxy and ethoxy groups are examples of functional groups that chemically bond to metals.

These are chemically bonded to hydroxyl groups derived from the oxide film present on the metal surface by hydrolysis.

Examples of the functional group that chemically bonding with the coating film include epoxy groups, glycidyl groups, amino groups, carboxyl groups, imidazole groups, mercapto groups, and acid anhydride groups. These cause chemical bonding by reacting with the components in the epoxy resin at the same time when the epoxy resin is cured.

In addition, vinyl groups, styryl groups, acrylic groups, and methacrylic groups are mentioned, and chemical bonding occurs by reacting with vinyl groups, acrylic groups, and methacrylic groups in the acrylic resin at the same time when the acrylic resin undergoes radical polymerization.

Functional groups that give corrosion inhibiting properties to metals include triazole, diazole, and triazole groups.

For example, 3-aminopropyltrimethoxysilane and N-2-(aminoethyl)-3-aminopropylmethyldimethoxysilane are examples of compounds of surface treatment agents that include a functional group that chemically bonds to a metal surface and a functional group that chemically bonds to a coating film.

A silane compound (b) that contains a functional group that chemically bonds to the metal surface and a functional group that provides corrosion resistance to the metal includes, for example, methylbenzotriazole trimethoxysilane.

The surface treatment agents are diluted with a solvent and applied to the metal structures. The solvent is a volatile organic solvent or water containing a volatile organic solvent, which must dissolve the surface treatment agents to form a clear solution.

Insufficient dissolution may cause separation of the liquid, resulting in unevenness during application, or in the case of a cloudy film, the cloudy material may agglomerate on the metal structures during application, causing the coating film to peel off without chemical bonding between the metal structures and the coating film. This can cause the coating film to delaminate.

Therefore, the surface treatment agents are prepared by weighing and mixing silane compound (a), which contains a functional group that chemically bonds to the metal surface and a functional group that chemically bonds to the coating film, and silane compound (b), which contains a functional group that provides corrosion inhibiting properties to metals the metal, to which a predetermined amount of organic solvent is added, followed by the gradual addition of water.

If water is added directly to a mixture of a silane compound, which contains a functional group for chemical bonding to metal surfaces and a functional group for chemical bonding to coating films (a), and a silane compound, which contains a functional group for chemical bonding to metal surfaces and a functional group for providing corrosion inhibiting properties to metals (b), the silane compounds react rapidly with water and bond with each other, forming insoluble matter, which reduces the surface treatment agents effectiveness.

The volatile organic solvent should be adjusted so that the contact angle of the surface treatment agents to the substrate is 90° or less; if the angle is greater than 90°, the wetting of the surface treatment agents to the substrate is insufficient, making it difficult to apply the surface treatment agents to the surface of the substrate and causing the coating film to peel.

Organic solvents include, for example, ethylene glycol-based, propylene glycol-based, and lactate-based solvents. For example, ethylene glycol monomethyl ether, ethylene glycol monoethyl ether, ethylene glycol monobutyl ether, propylene glycol monomethyl ether, propylene glycol monoethyl ether, propylene glycol monobutyl ether, methyl lactate, lactic acid ethyl lactate, etc. When volatile organic solvents and water are mixed, a mixing ratio of organic solvent:water=5:95 to 95:5 (mass ratio) is preferred.

The concentration of a mixture of a silane compound containing a functional group that chemically bonds to a metal surface (a) and a functional group that chemically bonds to a coating film and a silane compound containing a functional group that provides corrosion inhibiting properties to metals (b), dissolved in a volatile organic solvent and water is preferably 0.1 to 11% by mass. More preferably, it is 1-7% by mass.

Concentrations lower than 0.1 mass % are not effective as surface treatment agents, while concentrations higher than 11 mass % increase the viscosity of the surface treatment agents and cause uneven application of the surface treatment agents.

The concentration of silane compound containing a functional group that chemically bonds to the metal surface and a functional group that chemically bonds to the coating film (a) should be 0.05 mass % to 2% or more.

The concentration of silane compound containing a functional group that chemically bonds to the metal surface and a functional group that provides corrosion inhibiting properties to metals (b) should be between 0.05 and 9 mass %. This is discussed below in the examples. The addition of water is environmentally friendly by reducing amount of organic solvent as volatile components.

The coating film 31 is a coating film provided on the surface treatment layer. Examples of the coating film 31, it can be configured to the paints having an anti-corrosion function to prevent corrosion of the metal structure 11, base paints such as putty painted relatively thickly to correct the uneven shape of the surface of the metal structure 11, and paints having a smooth and vivid color formed on the base paints. The coating film 31 can be composed of one layer or multiple layers.

The thickness of the coating film 31 can be selected according to the type of coating film 31 and other factors. For example, if the coating film 31 is a coating film for the purpose of preventing corrosion of metal structures and improving design, it may have a thickness of 10 μm to 1000 μm.

Next, the method of forming paint part 405 of vehicle 401 is described. First, metal structures 11 molded into a predetermined shape are prepared, and coating films are formed on the metal structures 11 in the order of surface treatment layer 21, coating film 31, and so on. The surface treatment agents are applied to the metal structures, but before the surface treatment agents are applied, dirt and other contaminants on the surface of the metal structures are removed.

Stains may be removed by physical methods such as wiping, polishing, or blasting the surface, or chemically by organic solvents, detergents, etching, etc. Any of these methods may be used. Further, if the dirt is small enough that cannot be observed visually or by tentacles, it may not be removed.

The surface treatment agents can be applied by brush, roller, spray, or other common application methods. The method of forming the coating film 31 can be based on the composition (type, function, etc.) of the coating film 31, and known techniques can be applied as appropriate.

As described above, since paint part 405 of vehicle 401 has the above configuration, the metal structures and coating film can be maintained for a long period of time with strong adhesion. As a result, the coating film can be prevented from peeling off and corrosion of the metal structures can be prevented.

The invention is not limited to the examples described above.

The invention will be specifically described below based on examples, but the invention is not limited to these examples.

<Paint Part Creation>

The materials used in the examples and comparative examples are listed below.

### Example 1

[A] Metal Structures

(A-1) Metal materials: aluminum alloy (A5052), thickness: 3 mm, surface shape: flat (no steps)

[B] Surface Treatment Agents

(B-1) Surface treatment agents:

0.25 mass percent of N-2-(aminoethyl)-3-aminopropyltrimethoxysilane (KBM603 Shin-Etsu Chemical) as a silane compound, which contains a functional group that chemically bonds to the metal surface and a functional group that chemically bonds to the coating film (a), and 0.75 mass % of a silane coupling agent containing a benzotriazole group (X-12-1214A Shin-Etsu Chemical) as a silane compound, which contains a functional group that provides corrosion inhibiting properties to metals (b) are dissolved in a mixed solvent of ethylene glycol monobutyl ether 25:water 75 (mass ratio).

[C] Paints

(C-1) Solution-Based Paint Epoxy Resin Paint (Nippon Paint Co., Ltd.)

The surface of metal materials (A-1) as metal structures was degreased using isopropyl alcohol.

Surface treatment agents (B-1) were applied to the thoroughly dried surface, and after drying, a solution-based paint (C-1) was applied and heat-treated at 50° C. to produce a coating film with a thickness of 50 μm and result of example 1 was obtained.

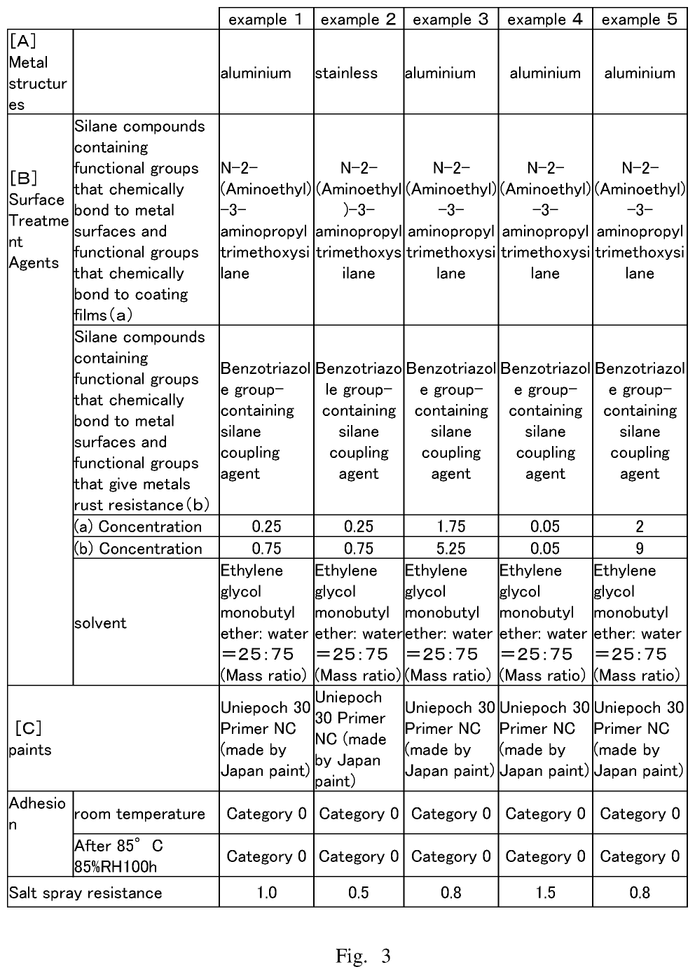

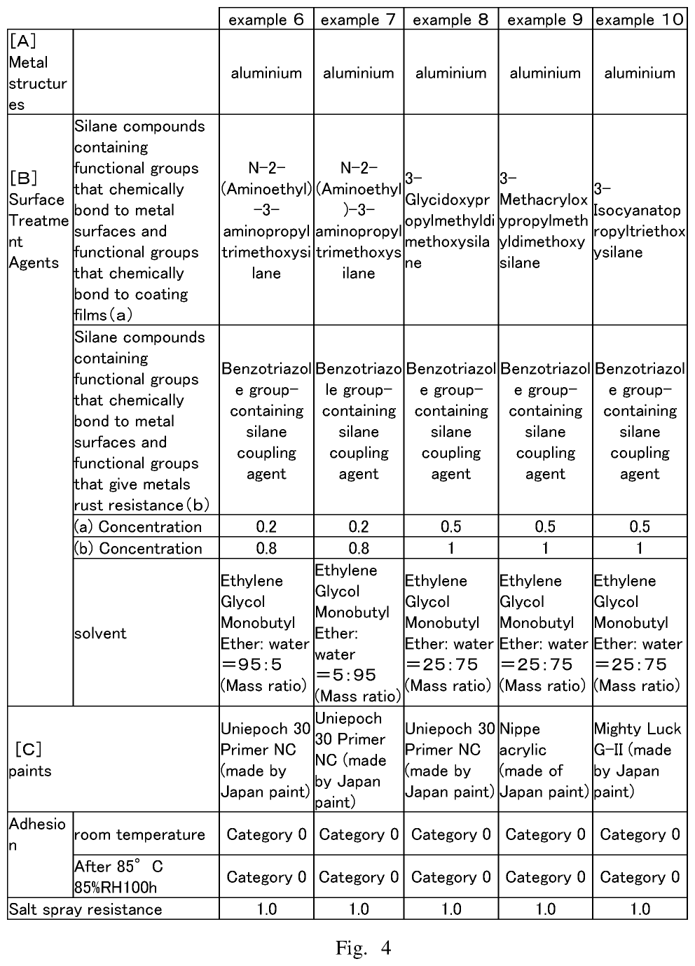

For examples 2 through 10, [A] metal structures, [B] surface treatment agents, and [C] paints as shown in table 1-1 in FIG. 3 and table 1-2 in FIG. 4 were used. Coating films were prepared in the same way as in Example 1, and the results were obtained.

### Example 2

[A] Metal Structures

(A-1) Metal materials: stainless steel, thickness: 3 mm, surface shape: flat (no step)

[B] Surface Treatment Agents

(B-1) Surface treatment agents: 0.25 mass % of N-2-(aminoethyl)-3-aminopropyltrimethoxysilane (KBM603 Shin-Etsu Chemical) and 0.75 mass % of silane coupling agent containing benzotriazole groups (X-12-1214A Shin-Etsu Chemical) 0.75 mass % was dissolved in a mixed solvent of ethylene glycol monobutyl ether 25:water 75 (mass ratio).

[C] Paints

(C-1) Solution-based paint epoxy resin paint (Nippon Paint Co., Ltd.)

The surface of metal materials (A-1) as metal structures was degreased using isopropyl alcohol. Surface treatment agents (B-1) were applied to the thoroughly dried surface, and after drying, a solution-based paint (C-1) was applied and heat-treated at 50° C. to produce a coating film with a thickness of 50 μm. Result of example 2 was obtained.

### Example 3

[A] Metal Structures

(A-1) Metal materials: aluminum alloy (A5052), thickness: 3 mm, surface shape: flat (no steps)

[B] Surface Treatment Agents

(B-1) Surface treatment agents: 1.75 mass % of N-2-(aminoethyl)-3-aminopropyltrimethoxysilane (KBM603 Shin-Etsu Chemical) and 5.25 mass % of silane coupling agent containing benzotriazole groups (X-12-1214A Shin-Etsu Chemical) 5.25 mass % was dissolved in a mixed solvent of ethylene glycol monobutyl ether 25:water 75 (mass ratio).

[C] Paints

(C-1) Solution-based paint epoxy resin paint (Nippon Paint Co., Ltd.)

The surface of metal materials (A-1) as metal structures was degreased using isopropyl alcohol. Surface treatment agents (B-1) were applied to the thoroughly dried surface, and after drying, a solution-based paint (C-1) was applied and heat-treated at 50° C. to produce a coating film with a thickness of 50 μm. Result of example 3 was obtained.

### Example 4

[A] Metal Structures

(A-1) Metal materials: aluminum alloy (A5052), thickness: 3 mm, surface shape: flat (no steps)

[B] Surface Treatment Agents

(B-1) Surface treatment agents: 0.05 mass % of N-2-(aminoethyl)-3-aminopropyltrimethoxysilane (KBM603 Shin-Etsu Chemical) and 0.05 mass % of silane coupling agent containing benzotriazole groups (X-12-1214A Shin-Etsu Chemical) 0.05 mass % was dissolved in a mixed solvent of ethylene glycol monobutyl ether 25:water 75 (mass ratio).

[C] Paints

(C-1) Solution-based paint epoxy resin paint (Nippon Paint Co., Ltd.)

The surface of metal materials (A-1) as metal structures was degreased using isopropyl alcohol. Surface treatment agents (B-1) were applied to the thoroughly dried surface, and after drying, a solution-based paint (C-1) was applied and heat-treated at 50° C. to produce a coating film with a thickness of 50 μm. Result of example 4 was obtained.

### Example 5

[A] metal Structures

(A-1) Metal materials: aluminum alloy (A5052), thickness: 3 mm, surface shape: flat (no steps)

[B] Surface Treatment Agents

(B-1) Surface treatment agents: N-2-(aminoethyl)-3-aminopropyltrimethoxysilane (KBM603 Shin-Etsu Chemical) 2 mass % and silane coupling agent containing benzotriazole group (X-12-1214A Shin-Etsu Chemical) 9 mass % was dissolved in a mixed solvent of ethylene glycol monobutyl ether 25:water 75 (mass ratio).

[C] Paints

(C-1) Solution-based paint Epoxy resin paint (Nippon Paint Co., Ltd.)

The surface of metal materials (A-1) as metal structures was degreased using isopropyl alcohol. Surface treatment agents (B-1) were applied to the thoroughly dried surface, and after drying, a solution-based paint (C-1) was applied and heat-treated at 50° C. to produce a coating film with a thickness of 50 μm. Result of example 5 was obtained.

### Example 6

[A] Metal Structures

(A-1) Metal materials: aluminum alloy (A5052), thickness: 3 mm, surface shape: flat (no steps) [B] Surface Treatment Agents

(B-1) Surface treatment agents: 0.2 mass % of N-2-(aminoethyl)-3-aminopropyltrimethoxysilane (KBM603 Shin-Etsu Chemical) and 0.8 mass % of silane coupling agent containing benzotriazole groups (X-12-1214A Shin-Etsu Chemical) 0.8 mass % was dissolved in a mixed solvent of ethylene glycol monobutyl ether 95:water 5 (mass ratio).

[C] Paints

(C-1) Solution-based paint epoxy resin paint (Nippon Paint Co., Ltd.)

The surface of metal materials (A-1) as metal structures was degreased using isopropyl alcohol. Surface treatment agents (B-1) were applied to the thoroughly dried surface, and after drying, a solution-based paint (C-1) was applied and heat-treated at 50° C. to produce a coating film with a thickness of 50 μm. Result of example 6 was obtained.

### Example 7

[A] Metal Structures

(A-1) Metal materials: aluminum alloy (A5052), thickness: 3 mm, surface shape: flat (no steps)

[B] Surface Treatment Agents

(B-1) Surface treatment agents: 0.2 mass % of N-2-(aminoethyl)-3-aminopropyltrimethoxysilane (KBM603 Shin-Etsu Chemical) and 0.8 mass % of silane coupling agent containing benzotriazole groups (X-12-1214A Shin-Etsu Chemical) 0.8 mass % was dissolved in a mixed solvent of ethylene glycol monobutyl ether 5:water 95 (mass ratio).

[C] Paints

(C-1) Solution-based paint epoxy resin paint (Nippon Paint Co., Ltd.)

The surface of metal materials (A-1) as metal structures was degreased using isopropyl alcohol. Surface treatment agents (B-1) were applied to the thoroughly dried surface, and after drying, a solution-based paint (C-1) was applied and heat-treated at 50° C. to produce a coating film with a thickness of 50 μm. Result of example 7 was obtained.

### Example 8

[A] Metal Structures

(A-1) Metal materials: aluminum alloy (A5052), thickness: 3 mm, surface shape: flat (no steps)

[B] Surface Treatment Agents

(B-1) Surface treatment agents: 0.5 mass % of 3-glycidoxypropyl methyl dimethoxysilane and 1 mass % of a silane coupling agent containing benzotriazole groups (X-12-1214A Shin-Etsu Chemical), The mixture was dissolved in a solvent mixture of ethylene glycol monobutyl ether 25:water 75 (mass ratio).

[C] Paints

(C-1) Solution-based paint epoxy resin paint (Nippon Paint Co., Ltd.)

The surface of metal materials (A-1) as metal structures was degreased using isopropyl alcohol. Surface treatment agents (B-1) were applied to the thoroughly dried surface, and after drying, a solution-based paint (C-1) was applied and heat-treated at 50° C. to produce a coating film with a thickness of 50 μm. Result of example 8 was obtained.

### Example 9

[A] Metal Structures

(A-1) Metal materials: aluminum alloy (A5052), thickness: 3 mm, surface shape: flat (no steps)

[B] Surface Treatment Agents

(B-1) Surface treatment agents: 0.5 mass % of 3-methacryloxypropyl methyl dimethoxysilane and 1 mass % of a silane coupling agent containing benzotriazole groups (X-12-1214A Shin-Etsu Chemical), The mixture was dissolved in a solvent mixture of ethylene glycol monobutyl ether 25:water 75 (mass ratio).

[C] Paints

(C-1) Solution-based paint epoxy resin paint (Nippon Paint Co., Ltd.)

The surface of metal materials (A-1) as metal structures was degreased using isopropyl alcohol. Surface treatment agents (B-1) were applied to the thoroughly dried surface, and after drying, a solution-based paint (C-1) was applied and heat-treated at 50° C. to produce a coating film with a thickness of 50 μm. Result of example 9 was obtained.

### Example 10

[A] Metal Structures

(A-1) Metal materials: aluminum alloy (A5052), thickness: 3 mm, surface shape: flat (no steps)

[B] Surface Treatment Agents

(B-1) Surface treatment agents: 0.5 mass % of 3-isocyanate propyltriethoxysilane and 1 mass % of a silane coupling agent containing benzotriazole groups (X-12-1214A Shin-Etsu Chemical), Dissolved in a mixed solvent of ethylene glycol monobutyl ether 25:water 75 (mass ratio).

[C] Paints

(C-1) Solution-based paint epoxy resin paint (Nippon Paint Co., Ltd.)

The surface of metal materials (A-1) as metal structures was degreased using isopropyl alcohol. Surface treatment agents (B-1) were applied to the thoroughly dried surface, and after drying, a solution-based paint (C-1) was applied and heat-treated at 50° C. to produce a coating film with a thickness of 50 μm. Result of example 10 was obtained.

### Comparative Example 1

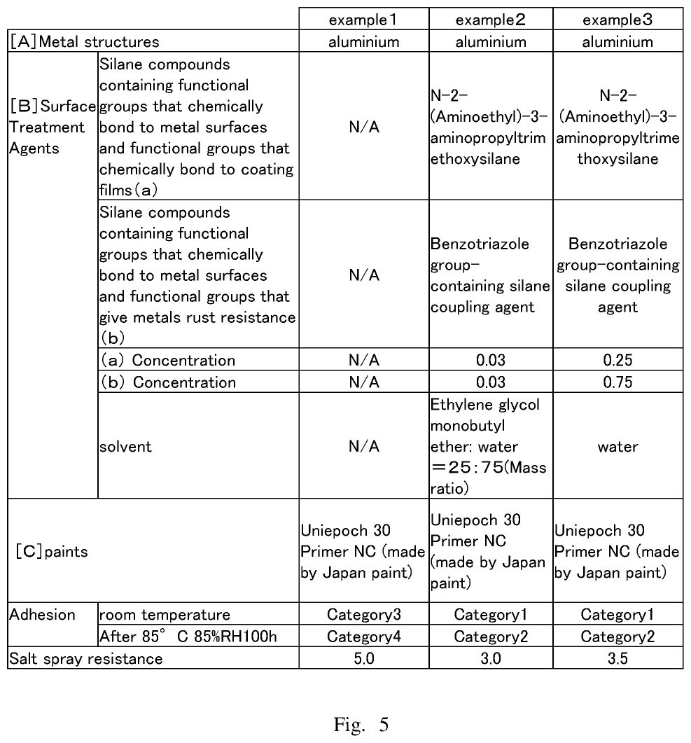

As in example 1, the surface of metal materials (A-1) as metal structures was degreased using isopropyl alcohol as shown in table 2 in FIG. 5. A coating film with a thickness of 50 μm was made by applying a solution-based paint (C-1) to the thoroughly dried surface and heat-treated at 50° C. to obtain comparative example 1.

### Comparison Example 2

As shown in table 2, a coating film was prepared as in example 1, except that the surface treatment agents were 0.03 mass % N-2-(aminoethyl)-3-aminopropyltrimethoxysilane (KBM603 Shin-Etsu Chemical) and 0.03 mass % silane coupling agent containing benzotriazole groups (X-12-1214A Shin-Etsu Chemical). The coating film was prepared in the same manner as in example 1, except for the addition of 0.03% by mass of a silane coupling agent containing a benzotriazole group (X-12-1214A Shin-Etsu Chemical Co., Ltd.).

### Comparative Example 3

As shown in table 2, the coating film was prepared in the same way as in example 1, except that only water was used as the solvent for the surface treatment agents, to obtain comparative example 3.

<Evaluation>

[Adhesion]

Adhesion was evaluated for examples 1 through 10 and comparative examples 1 through 3 using the cross-cut test (JIS K 5600-5-6). Adhesion was also evaluated for those left standing in an environment of 85° C. temperature and 85% relative humidity. In all cases, the examples showed good adhesion with no peeling and high reliability. On the other hand, in comparative examples 1-5, peeling was partially observed, and good adhesion could not be obtained.

[Neutral Salt Spray Resistance]

Examples 1 through 10 and comparative examples 1 through 3 were evaluated for neutral salt spray resistance (JIS K 5600-7-1). Crosscuts were made at least 20 mm away from the edge of the specimen to reach the substrate. After exposure to 5% NaCl at 35° C.×240H, abnormalities such as cracking, swelling, and whitening around the cross-cuts were checked, and the width of the abnormalities was indicated.

### REFERENCE SIGNS LIST

11 . . . metal structures
21 . . . Surface treatment layer
31 . . . coating film
401 . . . vehicle
402 . . . wheel
403 . . . side sliding door
404 . . . window
405 . . . paint part
406 . . . pantograph

1. A metal surface treatment agent comprising:
first silane compound containing a functional group that chemically bonds to the metal surface and a functional group that chemically bonds to the coating film,
second silane compound containing a functional group that chemically bonds to the metal surface and a functional group that provides rust inhibiting properties to the metal, and a solvent mixture of organic solvent and water.

2. A metal surface treatment agent according to claim 1, the solvent is adjusted so that the contact angle is 90° or less against to the metal surface serving as a base material.

3. A metal surface treatment agent according to claim 1,
the concentration of the first silane compound is 0.05% by mass or more and 2% by mass or less,
the concentration of the second silane compound is not less than 0.05% by mass but not more than 9% by mass of the metal surface treatment agent.

4. A metal surface treatment agent according to claim 1, the ratio of the mass ratio of said organic solvent to said water in a mixture of said organic solvent and said water as a solvent is in the range of 5:95 to 95:5.

5. A coated body in which a coating film is formed on a surface treatment layer formed by a metal surface treatment agent according to claim 1.

6. A railroad vehicle in which a coating film is formed on a surface treatment layer formed by a metal surface treatment agent according to claim 1.

7. A method for manufacturing surface treatment agents,
mixing first silane compound containing a functional group that chemically bonds to the metal surface and
a functional group that chemically bonds to the coating film and second silane compound containing a functional group that chemically bonds to the metal surface and a functional group that corrosion inhibiting properties to metals,
adding organic solvent and water.

8. A method for manufacturing a coated body
creating surface treatment layer by surface treatment agents comprising first silane compound containing a functional group that chemically bonds to the metal surface and a functional group that chemically bonds to the coating film,
second silane compound containing a functional group that chemically bonds to the metal surface and a functional group that provides rust inhibiting properties to the metal, and a solvent mixture of organic solvent and water and creating coating film on the surface treatment layer.
